(19) United States
(12) Patent Application Publication
(10) Pub. No.: US 2020/0283608 A1
(43) Pub. Date: Sep. 10, 2020

(54) THERMOPLASTIC MATERIAL

(71) Applicant: UMBERTO CHIANESE, POTENZA PICENA (MC) (IT)

(72) Inventor: UMBERTO CHIANESE, POTENZA PICENA (MC) (IT)

(21) Appl. No.: 16/759,891

(22) PCT Filed: Oct. 18, 2018
(86) PCT No.: PCT/IB2018/058084

§ 371 Date: Apr. 28, 2020

(30) Foreign Application Priority Data
Nov. 7, 2017 (EP) 17200475.6

(51) Int. Cl. C08L 23/16; A43B 13/04; B29B 17/04; B29B 17/00; E04C 1/40; E04C 2/26; E04B 1/90

(52) U.S. Cl. CPC C08L 23/16; A43B 13/04; B29B 17/0404; B29K 2023/16; E04C 1/40; E04C 2/26; E04B 1/90; B29B 17/0042

(57) ABSTRACT

A thermoplastic material is based on a mixture of thermoplastic and non-thermoplastic polymers, optionally recycled materials including tires. One thermoplastic material comprises a non-thermoplastic phase, comprising a mixture of natural and synthetic rubber and optionally a cross-linked polyurethane, and a thermoplastic phase comprising a thermoplastic polymer, wherein said thermoplastic material preferably comprises 10% to 40% by weight of a thermoplastic polymer, 0% to 30% by weight of across-linked polyurethane and 10% to 85% by weight of a mixture of natural and synthetic rubber, with the provision that the non-thermoplastic phase is in an amount of between 40% and 85% by weight. An process for obtaining the thermoplastic material is also disclosed.

### TECHNICAL FIELD OF THE INVENTION

The present invention relates to a thermoplastic material and a process for obtaining it. In particular, the invention relates to a thermoplastic material based on a mixture of thermoplastic and non-thermoplastic polymers, preferably from recycled materials. One example for all, for the enormous produced amount produced, is that of end-of-life tyres (ELT).

### PRIOR ART

The reuse of waste materials, of industrial type or deriving from private use, is an issue which has still not been completely solved. The biggest problems occur with thermosetting-polymer-based materials, i.e. with polymers which have undergone a vulcanization or cross-linking process. Typical examples of such materials are polyurethanes and natural or synthetic rubbers, the first having been subject to a cross-linking reaction of polyols with polyisocyanates and the second to so-called vulcanization.

Polyurethanes are used for a wide range of applications. In foamed form, their main uses are in the refrigeration industry, in the building (heat insulation and soundproofing) and the shipbuilding sectors, while in the compact elastic form they constitute the main material for manufacturing seals, soft components for various purposes (telephony, toys, etc.), textile fibres and soles for shoes.

Natural or synthetic rubbers are normally used in the making of tyres, shoe soles, seals etc.

The main problem related to the use of both of these materials is precisely their property of being thermosetting polymers. During the manufacturing step, this need is solved by performing the cross-linking process/vulcanization process inside the mould for forming the manufactured item, but instead when the manufactured item has reached the end of its life the main problem is its recycling. Cross-linked polyurethanes and tyres cannot be formed again in new manufactured items because they are not thermoplastic materials.

Therefore, end-of-life tyres, which quantitatively constitute the largest single source of recycled rubber, undergo a grinding process, result of which (rubber powder) is used for making modified asphalt, insulating materials and for urban furnishings and as a filler for artificial grass sports fields. In all these uses, the rubber powder is always visually distinguishable from the polymeric substrate in which it is included and also confers poor abrasion resistance to the material which tends to crumble by friction. Thermosetting polyurethanes may be ground and then reused as filling material.

Rubber de-vulcanization or polyurethane glycolysis methods exist, which make it possible to re-obtain the initial materials, but such processes are not economically advantageous.

In order to overcome these problems, thermoplastic elastomers (TPE) have been proposed which have properties similar to those of tyres, but which have the great advantage of being formable again by moulding, by virtue of their thermoplasticity. However, such materials have not entirely replaced rubber, especially with regard to the rubber for tyres or for shoes soles, for which the need to find an economically advantageous use for such waste materials still exists.

### SUMMARY OF THE INVENTION

The drawbacks outlined above are at least partly solved by a thermoplastic material obtained according to a method which envisages the mixing of non-thermoplastic material, preferably waste material, such as natural and synthetic rubbers and optionally polyurethanes and a relatively small amount of a thermoplastic polymer.

The polyurethanes and rubbers may also be virgin, but the economic advantage of the product of the invention and of the process for preparing it derives from the use of polyurethane and waste rubber. It has been seen that the introduction, in a polyurethane/rubber compound, of a variable amount from 10% to 40% by weight of a thermoplastic material confers to the material deriving from it the property of thermoplasticity which allows a constant reuse of it in thermoforming processes.

Therefore, it is an object of the present invention a thermoplastic material as defined in claim 1 and in its preferred embodiments, in the claims from 2 to 16 and 18, the text of which is an integral part of the present description.

It is a further object of the invention a process as outlined in claim 17, which makes it possible to obtain a final thermoplastic material in which the waste rubber powder is visually indistinguishable and has improved mechanical properties (abrasion resistance, grip, etc.).

### DETAILED DESCRIPTION OF THE INVENTION

The present invention relates to a thermoplastic material obtained according to a process which involves mixing a non-thermoplastic phase, comprising a mixture of natural and synthetic rubbers and optionally cross-linked polyurethanes, with a relatively small amount of a thermoplastic polymer.

Therefore, the thermoplastic material of the invention comprises a non-thermoplastic phase, comprising a mixture of natural and synthetic rubber and optionally a cross-linked polyurethane, and a thermoplastic phase comprising a thermoplastic polymer.

The thermoplastic material of the invention preferably comprises 10% to 40% by weight of a thermoplastic polymer, 0% to 30% by weight of a cross-linked polyurethane and 10% to 85% by weight of a mixture of natural and synthetic rubber, with the provision that the non-thermoplastic phase is in an amount of between 40% and 85% by weight.

The thermoplastic material of the invention may also contain cross-linked polymers or copolymers of various nature, deriving from waste materials or recycling, in the non-thermoplastic phase.

In preferred embodiments, the thermoplastic material of the invention comprises an amount from 20% to 35% by weight of thermoplastic polymer, from 0% to 20% by weight of the cross-linked polyurethane and from 30% to 60% by weight of a mixture of natural and synthetic rubber. In even more preferred embodiments, the mixture of natural and synthetic rubber comprises a vulcanized rubber, in particular a rubber powder from end-of-life tyres (ELT) and/or of other manufactured items.

The cross-linked polyurethane may be a polyurethane from polyether diol, a polyurethane from polyester diol or mixtures thereof and preferably is a waste material, e.g. from shoe manufacturing.

The polyurethane, when present, is in form of ground material, preferably with a particle size from 1 to 5 mm.

The mixture of natural and synthetic rubber comprises a natural or synthetic rubber and EPDM (ethylene-propylene-diene monomer terpolymer). In preferred embodiment, the mixture comprises from 30% to 80% by weight of EPDM and from 70% to 20% by weight of natural or synthetic rubber.

The natural or synthetic rubber can be a stirene-butadiene rubber (SBR), a nitrile rubber (NBR), an isoprene rubber, a butadiene rubber, a chloroprene rubber (Neoprene®), a nitrile chloroprene rubber (NCR), an isobutylene-isoprene rubber (IIR), a polynorbornene rubber (PNR), a transpolyoctenamer rubber, an EPM rubber (ethylene-propylene monomer), an acrylic rubber (ACM), EAM rubber (ethylene-vinyl acetate), chlorosulfonated ethylene rubber or mixtures thereof.

Preferably, the natural or synthetic rubber is waste material.

Natural or synthetic rubbers are in form of powder, preferably with particle size from 400 to 600 microns, for use in articles for shoes, or with particle size from 1000 microns up to 3.5 mm in the building sector.

In preferred embodiments, the ethylene-propylene-diene terpolymer (EPDM) is formed by about 45-75%, more preferably about 70%, of ethylene, 13-43%, more preferably about 25%, propylene and 2.5-12%, more preferably about 5%, of diene. The diene is preferably ethylidene-norbornene (ENB).

The thermoplastic polymer may be of various nature, according to the type of application to which the material will be dedicated. Such polymer confers given specific technical properties to the material of the invention and may be chosen from the following non-exhaustive list, for example:
polyethylene (PE) homopolymer, in particular LDPE (low density PE), HDPE (high density PE), PE-HMW (high molecular weight PE), PE-UHMW (ultra high molecular weight PE). PEs are soft, flexible, semi-crystalline thermoplastic materials and their properties and structures confer a massive chain branching with variable lengths innovative thermoplastic material such as to promote the blend during the step of melting;
modified PE, in particular PEX+PSAC (cross-linked PE+polysaccharide/starch compound), chlorinated and chlorosulfonated PE, PE-ULD (ultralight PE), EVA (polyethylenevinylacetate), EVAL (polyethylenevinylalcohol), EEA (ethylene-ethyl acrylate copolymers), EBA (ethylene-butyl acrylate copolymers), EMA (ethylene-methyl acrylate copolymers), EAA (ethylene-acrylic acid copolymers), EMAA (ethylene-methacrylic acid copolymers), E/P (ethylene-propylene copolymers), EIM (ethylene ionomer copolymer), COC
   (cyclopolyolefin copolymers), ECB (ethylene-bitumen copolymer blend), ETFE (ethylene-tetrafluoroethylene copolymer);
   PDCPD (polycyclopentadiene), vinyl polymers, PS (polystyrene), PMS (poly-alpha-methylstyrene), TPU (thermoplastic polyurethanes), TPS (styrene-based thermoplastic polymers), EPS (expanded polystyrene), PVC (polyvinyl chloride), PVC-P (plasticized polyvinyl chloride), homo- and copolymers of PVC, PVAL (polyvinylalcohol), PVFM (polyvinylformal), PVK (polyvinylketone), PTFE (polytetrafluoroethylene), PVDF (polyvinylidene fluoride), PVF (polyvinyl fluoride), PCTFE (polychlorotrifluoroethylene), ECTFE (ethylene-chlorotrifluoroethylene copolymer), ETFE (ethylene-tetrafluoroethylene copolymer), FEP (polyfluoroethylene-propylene), TFEHFPVDF (tetrafluoroethylene-hexafluoropropylene-vinylidenfluoride copolymer), FKM (fluorinated elastomer), EPDM (ethylene-propylene-diene elastomer), FFKM (perfluorinated elastomer);
PAE (polyacrylic ester), PAN (polyacrylonitrile), PMA (polymethacrylate), PBA (polybutyl acrylate), ANBA (acrylonitrile-methylmethacrylate copolymer), ANMA (acrylonitrile-butadiene-acrylate copolymer), PMMA (polymethylmethacrylate), AMMA (acrylonitrile-methylmethacrylate copolymer), MABS (methyl methacrylate-acrylonitrile-butadiene-styrene copolymer), MBS (methacrylate-butadiene-styrene copolymer), PMMI (polymethacryl-methylimide), PMMA-HI, MMA-EML (methylmethacrylate-EML), PMMA+ABS (polymethylmethacrylate+acrylonitrile-butadiene-styrene);
   POM-H (polyoxymethylene-H), POM-R (polyoxymethylene-R), POM PUR (polyoxymethylene+polyurethane);
PA (polyamides), AB, AA/BB, polyamide elastomers TPE-A, polyesteramides PEBA, PA-RIM, PMPI (poly-m-phenylene-isophthalamide), PPTA (poly-p-phenylene terephthalamide);
SP (aromatic polyesters), PC (polycarbonates of bisphenol-A), PC-BPA, PC-TMC/BPA, PPC (polyphtalate-carbonate);
   polycarbonate based on aliphatic dicarboxylic acids and mixtures thereof, PC+ABS, ASA (acrylonitrile-styrene-acrylester copolymer), AES (acrylonitrile-ethylene-propylene-diene-styrene copolymer), PMMA+PS, PET (polyethylene terephthalate), PPE+SB (polyphenyl ether+styrene-butadiene copolymer), PS-HI (polystyrene HI), PPE (polyphenyl ether), PP-cop (polypropylene copolymers), SMA (styrene-maleic anhydride copolymer), PTP, PBT (polybutyleneterephtalate), PTT
   (polytrimethylene terephthalate), PET+PBT, MSB, PSU (polysulfone);
thermoplastic polyester elastomers;
polyesters of aromatic diols and carboxylic acid, PAR (polyarylates), PBN (polybutylene naphtalate), PEN (polyethylene naphthalate);
   polyarylsulfides and polyarylsulfones, PPS (polyphenylene sulfide), PASU, PSU (polysulfone), PES (polyethersulphone), PPSU (polyphenylenesulfone), PSU+ABS;
   polyarylketones and derivatives, PAEK (polyarylketone), PEK (polyetherketone), PEEK (polyether-etherketone), PEEEK (polyether-ether-ethereketone), PEKK (polyethereketoneketone), PEEKK (polyether-ether-ketoneketone), PEEKEK (polyether ether-ketonetherketone), PEKEEK (polyether-ketone-ether-etherketone), PAEK+PI (polyarylketone+polyimide); thermoplastic polyimides, PAI (polyamidoimide), PEI (polyetherimide), PISO (polyimide-sulfone), PMI (polymethacrylimide), PMMI (polymethacryl-methylimide), PARI (polyarylimide), PESI (polyesterimide);
thermoplastic polyurethanes TPU;
resins based on unsaturated polyester UP;
epoxy resins EP;
   natural polymers derived from cellulose and starch: CA (cellulose acetate), CTA (cellulose triacetate), CP (cellulose propionate), CAP (cellulose acetopropionate), CAB (cellulose acetate butyrate), NC (cellulose nitrate), EC (ethyl cellulose), MC (methylcellulose), CMC (carboxymethylcellulose), CH (hydrated cellulose), PSAC (polysaccharide starch);
   or mixtures thereof.

The thermoplastic material of the invention may further comprise a plasticizer, in order to increase the tenacity of the material.

The plasticizer may be contained in a percentage by weight variable from 0% to 15% by total weight of the material, preferably from 2% to 12% by weight.

A monomeric plasticizer or a polymeric plasticizer can be used. The plasticizer may be selected from organic phosphates, such as tributyl phosphate, tris (2-ethylhexyl) phosphate or trioctyl phosphate, triphenyl phosphate, tricresyl phosphate and cresyl dip enyl phosphate; adipates, sebacates or esters of fatty acids such as butyl adipate of 2-ethylhexyl adipate or octyl adipate dicicloesile, adipate methylcyclohexyl, sebacate, butyl sebacate, 2-ethylhexyl acrylate or sebacate, octyl sebacate of benzyl and stearate of amyl; phthalates such as dimethyl phthalate, diethyl phthalate, dibutyl phthalate, diamyl phthalate, di-2-ethylhexylphthalate or dioctyl phthalate, diisononyl p thalate, dicapryl phthalate, diallylpht alate, cyclohexyl phthalate, dimethyl cyclohexyl phthalate, dimethoxy ethilphthalate and dibutoxy ethylphtalate and phthalate of isodecyl; glyceryl diacetate and glyceryl triacetate.

Preferably, the plasticizer is selected from DOA (dioctyl adipate) and DIDP (diisodecyl phthalate).

The thermoplastic material of the invention can also contain other additives, preferably selected, according to the use for which the material is intended, from slipping agents, lubricants, stabilizers, antistatic agents, flame retardants, dyes, flexibilizers, fillers, reinforcing agents and foaming agents. These additives can be selected from those normally used in the sector and can be either organic or inorganic.

The foaming agents may be either endothermic or exothermic and will be selected, together with the moulding technique, according to whether a closed-cell or an open-cell foamed material is desired.

Such additives may be contained in an overall percentage by weight variable from 0% to 15% by total weight of the material, preferably from 3% to 13% by weight.

In preferred embodiments, the thermoplastic material comprises an amount from 15% to 35% by weight of a thermoplastic polymer selected from a polyolefin, a styrene polymer or copolymer, a TPU or mixtures thereof, from 0% to 20% by weight of crosslinked waste polyurethane and from 30% to 60% by weight of natural and synthetic rubber mixture as described above. Even more preferably, the polyolefin is selected from polypropylene, polyethylene and HDPE; the styrene polymer or copolymer is selected from polystyrene and SBS; the natural or synthetic waste rubber is an ELT rubber powder and/or other manufactured items.

The thermoplastic material of the invention may be obtained by means of the process described below, which comprises the following steps:

a) grinding the cross-linked polyurethane, when present;
b) grinding the natural or synthetic rubber to yield a powder;
c) intimately hot mixing the powder of step b) with EPDM to yield a homogeneous compound containing between 30% and 80% by weight of EPDM;
d) mixing the homogeneous compound of step c) and, when present, the ground cross-linked polyurethane with the thermoplastic polymer, up to the formation of a homogeneous mixture;
e) optionally, adding liquid components (e.g. plasticizers) to the mixture of step d) and further mixing in a turbo-mixer up to the absorption of the liquid;
f) extruding the mixture of step d) or e).

The intimate mixing of the natural or synthetic rubber powder with EPDM in step c) may be performed in a Banbury mixer. The intimate mixing temperature may reach up to about 100° C.

The homogeneous compound obtained in step c) is preferably ground to a fine particle size by means of a cutter before the subsequent mixing with the thermoplastic polymer.

The extruded material may be recovered in form of granules (using a cutter downstream of the extruder), sheet or cake, according to the extruder used as a function of the final use of the material.

The mixture may be extruded by single-screw extruders, dosing extruders, cascade or tandem extruders, rapid adiabatic extruders, planetary extruders, screw extruders with melt separation, barrier screw extruders or twin-screw extruders. By way of non-limiting example, the extrusion process performed using a single-screw extruder is briefly described: the extrusion mass is fed by a loading hopper to a screw which rotates in a cylinder with heated zones; here the plastic material is melted mainly by friction and partially by thermal conduction, optionally degassed and then homogenized by cutting and compression action. The conveying effect derives from the friction force applied by the surfaces of the screw and the cylinder on the mass to be extruded. The temperatures required for extrusion are the following:
under the hopper: varying from 80° C. to 270° C.,
in the centre screw: varying from 80° C. to 270° C., near the degassing area: varying from 80° C. to 270° C.,
at outlet to cutter: varying from 80° C. to 270° C. The extrusion speed varies according to the properties one desires to attribute to the innovative thermoplastic material and therefore also of the set temperature. The unit of measurement of the speed is typically the ratio of kilos or volumes of extruded mass per hour.

By way of non-limiting example, for a thermoplastic material the mixture of which is suited for making soles for shoe, it is preferable but not essential to use a single-screw extruder of length from 5 to 6 metres, the screw being of progressive or of dosing type with diameter of 90 mm. The extrusion mass is inserted into the loading hopper, the temperature under the hopper must be 140° C. and the screw revolutions are programmed for an extrusion of 500 kg/h, the temperature in the centre of the screw must be 150°/160° C., near the degassing area it will be 120°/130° C. and at the outlet to the cutter the temperature will be 100°/110° C.

By way of non-limiting example, for a thermoplastic material the mixture of which is suited for making bricks, interior and exterior flooring, also floating, heat insulating/soundproofing panels to be used in the building sector, it is preferable but not essential to use a twin-screw extruder of length from 5 to 6 metres, the screw being of co-rotating type with diameter of 115 mm.

The extrusion mass is inserted into the loading hopper, the temperature under the hopper must be 160°/170° C. and the screw revolutions are programmed for an extrusion of 500/600 kg/h, the temperature in the centre of the screw must be 180°/190° C., near the degassing area it will be 160° C. and at the outlet to the cutter the temperature will be 150° C.

It is therefore apparent that the type of extruder used can vary, although not in defining manner, as a function of the mixture used as mass to be extruded and the properties to be attributed to the thermoplastic material of the invention.

The particle size of the powders or granulates used in the method described above may be determined, for example, by sieving.

In particular embodiments, the thermoplastic material comprises an amount from 15% to 25% by weight of thermoplastic polyurethane (TPU) or SBS, from 10% to 20% by weight of cross-linked waste polyurethane in granules sized 1-5 mm, from 25% to 60% by weight of mixture of waste rubber powder with a grain size from 400 to 600 microns and EPDM, a plasticizer, preferably DIDP, in an amount of 8-10% by weight, dyes in an amount of 1-3% by weight, silica in an amount of 4-6% by weight, and a lubricant in an amount of 2-4% by weight.

This material is particularly suited for making soles of shoe, and therefore a further object of the invention is a sole for shoes made of such material.

In other particular embodiments, the thermoplastic material comprises an amount from 15% to 35% by weight of a polyolefin, preferably polypropylene, or of polystyrene, from 5% to 15% by weight of cross-linked waste polyurethane in granules sized 1-5 mm, from 25% to 60% by weight of a mixture of waste rubber powder with grain size from 400 microns to 3.5 mm and EPDM, a plasticizer, preferably dioctyl adipate, in an amount of 3-7% by weight, dyes in an amount of 1-3% by weight, silica in an amount of 4-6% by weight, and a lubricant in an amount of 2-4% by weight.

Such material is particularly suited for use in the building sector, and therefore a further object of the invention is a brick, floor for exteriors and interiors also raised, a heat insulating/soundproofing panel for building made with this material.

In yet other particular embodiments, the thermoplastic material comprises an amount from 20% to 35% by weight of a polyolefin, preferably HDPE, or of PVC (polyvinyl chloride), from 10% to 20% by weight of cross-linked waste polyurethane in granules sized 1-5 mm, from 25% to 60% by weight of a mixture of waste rubber powder with grain size from 400 to 600 microns and EPDM, a plasticizer, preferably dioctyl adipate, in an amount of 2-4% by weight, dyes in an amount of 1-3% by weight, silica in an amount of 4-6% by weight, and a lubricant in an amount of 2-4% by weight.

Expanding materials are added to the mixture in order to confer the lightness and thermal/acoustic insulation properties to the innovative thermoplastic material.

Foaming materials for plastics are known, usually used to confer a greater heat insulation ability to said plastic materials because they create a plurality of pores in it. The foaming materials of known type are divided into two categories: exothermic expanding materials and endothermic expanding materials.

The first generate heat and develop a gas during the step of expanding, usually nitrogen (e.g. azodicarbonamide, also known as carbamoyliminourea, encapsulated isopentane, 5-phenyltetrazole and benzene sulfonyl hydrazide); these types of foaming material, when subjected to heating, decompose releasing heat and a gas, such as nitrogen, carbon dioxide and ammonia. The decomposition reaction continues because of the heat produced by the release of gas and may not be interrupted by simple cooling measures.

The endothermic foaming materials absorb heat, whereby degrading and generating neutral gases (e.g. carbon dioxide, but the most known ingredients are carbonates and carboxylic acids). Their advantage is in that when the heat supply is interrupted, gas production stops and resumes if heat is further provided. Consequently, the endothermic foaming materials are easier to handle during processing.

The foaming material, if present, is contained in the mixture in amounts ranging from 5% to 10% by weight.

The thermoplastic material of the invention thus solves the problem initially posed of making thermoformable, for an indefinite number of times in a wide range of applications (shoes, building, automotive parts, packaging, clothing, toys, etc., in all sectors in which the material will be used) and at a low cost, a waste material which would othenwise be recyclable only for limited uses.

It was also worth noting that the material according to the invention, if compared with thermoplastic polymeric materials commonly used in the applications described above (e.g. SBS-based polymers used in the shoe sole and building sector) and containing rubber powder displays improved mechanical properties.

In particular, the material of the invention, in its compact form of specific weight of about 1 g/cm3
(determined with the method of ISO 2781: 2008), has a loss of volume by abrasion (abrasion resistance determined by the method of UNI EN 12770: 2001) comprised between 100 and 150 mm3 and a tear strength
(determined by the method of ISO 20872) between 15 and 20 N/mm.

The material of the invention, in its foamed form of specific weight of about 0.60 g/cm3 (determined with the method of ISO 2781: 2008), has a loss of volume by abrasion (abrasion resistance determined by the method of UNI EN 12770: 2001) comprised between 150 and 190 mm3 and a tear strength (determined by the method of ISO 20872) between 10 and 15 N/mm.

Conventional materials used, for example, in the field of soles for shoes, based on SBS in compact form (specific weight about 1 g/cm3) and in foamed form (specific weight approximately 0.65 g/cm3), have a volume loss by abrasion (abrasion resistance with the method of UNI EN 12770: 2001) of about 250 mm3 and of about 400 mm3 and a tear strength (determined with the method of ISO 20872) of about 9 N/mm and about 8 N/mm, respectively.

By way of non-limiting example, some formulations according to the invention (the percentages are by weight) are listed below.

### Example 1—Soles for Shoes

Polyurethane-waste 20%

Rubber powder+EPDM mixture 50%

TPU-thermoplastic waste 25%

Dyes 5%.

### Example 2—Soles for Shoes

Polyurethane-waste 10%

Rubber powder+EPDM mixture 50%
SBS rubber 35%

Dyes 5%.

### Example 3—Soles for Shoes Made of Foamed Material Polyurethane-Waste

10%

Rubber powder+EPDM mixture 50%

TPU-thermoplastic waste or SBS rubber 30%
Dyes 5%

Foaming agent 5%.

The foaming agent may be, for example, Expancel 930 du/mb 120.

The addition in the mixture of Expancel 930 du/mb 120 (closed-cell endothermic foaming agent) allows the gas enclosed inside of the microspheres in contact with the heat to inflate and then expand the innovative thermoplastic material, whereby conferring a specific weight of 0.50/0.55 g/dm3 to it.

### Example 4—Building Material (Flooring)

Polyurethane-waste 10%

Rubber powder+EPDM mixture 50%
PVC 35%

Dyes 5%.

### Example 5—Building Material (Flooring)

Polyurethane-waste 10%

Rubber powder+EPDM mixture 50%
PVC 30%
Dyes 5%

Foaming agent 5%.

The foaming agent may be, for example, Expancel 930 du/mb 120.

The addition in the mixture of Expancel 930 du/mb 120 (closed-cell endothermic foaming agent) allows the gas enclosed inside of the microspheres in contact with the heat to inflate and then expand the innovative thermoplastic material, whereby conferring a specific weight of 0.25/0.30 g/dm3 to it.

### Example 6—Building Material (Insulating and Soundproofing Panels)

Polyurethane-waste 10%

Rubber powder+EPDM mixture 50% Polypropylene 35%

Dyes 5%.

### Example 7—Building Material (Insulating and Soundproofing Panels)

Polyurethane-waste 5%

Rubber powder+EPDM mixture 50%

Polypropylene 30%
Dyes 5%

Foaming agent 10%.

### Example 8—Pallet Material

Polyurethane-waste 15%

Rubber powder+EPDM mixture 50%
HDPE 30%

Dyes 5%.

It is worth noting that the variation of the percentage of the foaming agent determines a corresponding variation of the specific weight of the innovative thermoplastic material which is obtained.

It is also worth noting that the same foaming effects can be obtained with exothermic foaming agents but endothermic agents are preferable for the reasons described above.

It is apparent that only some particular embodiments of the present invention have been described, to which a person skilled in the art will be able to make all the changes necessary to adapt it to particular applications, without because of this departing from the scope of protection of the present invention.

1. Thermoplastic material comprising a non-thermoplastic phase, comprising a mixture of natural and synthetic rubber and optionally a cross-linked polyurethane, and a thermoplastic phase comprising a thermoplastic polymer.

2. Thermoplastic material according to claim 1, wherein said thermoplastic material comprises 10% to 40% by weight of a thermoplastic polymer, 0% to 30% by weight of a cross-linked polyurethane and 10% to 85% by weight of a mixture of natural and synthetic rubber, with the provision that the non-thermoplastic phase is in an amount of between 40% and 85% by weight.

3. Thermoplastic material according to claim 1, comprising an amount from 20% to 35% by weight of thermoplastic polymer, 0% to 20% by weight of cross-linked polyurethane and 30% to 60% by weight of a mixture of natural and synthetic rubber, the cross-linked polyurethane, when present, being a waste material and the mixture of natural and synthetic rubber comprising a rubber powder of end-of-life tyres (ELT) or other waste articles.

4. Thermoplastic material according to claim 1, wherein the cross-linked polyurethane, when present, is selected from a polyether diol polyurethane, a polyester diol polyurethane or mixtures thereof, preferably in ground form with grain size of between 1 and 5 mm.

5. Thermoplastic material according to claim 1, wherein the mixture of natural and synthetic rubber comprises a natural or synthetic rubber and EPDM (ethylene-propylene-diene monomer terpolymer).

6. Thermoplastic material according to claim 5, wherein the mixture of natural and synthetic rubber comprises between 30% and 80% by weight of EPDM and between 70% and 20% by weight of natural or synthetic rubber.

7. Thermoplastic material according to claim 1, wherein the natural or synthetic rubber is selected from a styrene-butadiene rubber (SBR), a nitrile rubber (NBR), an isoprene rubber, a butadiene rubber, a chloroprene rubber (Neoprene®), a nitrile chloroprene rubber (NCR), an isobutene-isoprene rubber (IIR), a polynorbornene rubber (PNR), a transpolyoctenamer rubber, an EPM (ethylene propylene monomer) rubber, an acrylic rubber (ACM), an EAM (ethylene-vinyl acetate) rubber, an ethylene chlorosulphonated rubber or mixtures thereof, preferably in form of powder, with grain size of 400 to 600 microns for use in articles for shoes or with grain size from 1000 microns up to 3.5 mm for use in the building sector.

8. Thermoplastic material according to claim 6, wherein the ethylene-propylene-diene terpolymer (EPDM) consists of 45-75%, or about 70%, ethylene, 13-43%, or about 25%, propylene, and 2.5%-12%, or about 5%, diene, and wherein the diene is preferably ethylidene norbornene (ENB).

9. Thermoplastic material according to claim 1, wherein the thermoplastic polymer is selected from:
polyethylene (PE) homopolymer, in particular LDPE (low density PE), HDPE (high density PE), PE-HMW (high molecular weight PE), PE-UHMW (ultra high molecular weight PE);
modified PE, in particular PEX+PSAC (cross-linked PE+polysaccharide/starch compound), chlorinated and chlorosulfonated PE, PE-ULD (ultralight PE), EVA (polyethylenevinylacetate), EVAL (polyethylenevinylalcohol), EEA (ethylene-ethyl acrylate copolymers), EBA (ethylene-butyl acrylate copolymers), EMA (ethylene-methyl acrylate copolymers), EAA (ethylene-acrylic acid copolymers), EMAA (ethylene-methacrylic acid copolymers), E/P (ethylene-propylene copolymers), EIM (ethylene ionomer copolymer), COC (cyclopolyolefin copolymers), ECB (ethylene-bitumen copolymer blend), ETFE (ethylene-tetrafluoroethylene copolymer); PDCPD (polycyclopentadiene), vinyl polymers, PS (polystyrene), PMS (poly-alpha-methylstyrene), TPU (thermoplastic polyurethanes), TPS (styrene-based thermoplastic polymers), EPS (expanded polystyrene), PVC (polyvinyl chloride), PVC-P (plasticized polyvinyl chloride), homo- and copolymers of PVC, PVAL (polyvinylalcohol), PVFM (polyvinylformal), PVK (polyvinylketone), PTFE (polytetrafluoroethylene), PVDF (polyvinylidene fluoride), PVF (polyvinyl fluoride), PCTFE (polychlorotrifluoroethylene), ECTFE (ethylene-chlorotrifluoroethylene copolymer), ETFE (ethylene-tetrafluoroethylene copolymer), FEP (polyfluoroethylene-propylene), TFEHFPVDF (tetrafluoroethylene-hexafluoropropylene-vinylidenfluoride copolymer), FKM (fluorinated elastomer), EPDM (ethylene-propylene-diene elastomer), FFKM (perfluorinated elastomer);
PAE (polyacrylic ester), PAN (polyacrylonitrile), PMA (polymethacrylate), PBA (polybutyl acrylate), ANBA (acrylonitrile-methylmethacrylate copolymer), ANMA (acrylonitrile-butadiene-acrylate copolymer), PMMA (polymethylmethacrylate), AMMA (acrylonitrile-methylmethacrylate copolymer), MABS (methyl methacrylate-acrylonitrile-butadiene-styrene copolymer), MBS (methacrylate-butadiene-styrene copolymer), PMMI (polymethacryl-methylimide), PMMA-HI, MMA-EML (methylmethacrylate-EML), PMMA+ABS (polymethylmethacrylate+acrylonitrile-butadiene-styrene);
POM-H (polyoxymethylene-H), POM-R (polyoxymethylene-R), POM+PUR (polyoxymethylene+polyurethane);
PA (polyamides), AB, AA/BB, polyamide elastomers TPE-A, polyesteramides PEBA, PA-RIM, PMPI (poly-m-phenylene-isophthalamide), PPTA (poly-p-phenylene terephthalamide);
SP (aromatic polyesters), PC (polycarbonates of bisphenol-A), PC-BPA, PC-TMC/BPA, PPC (polyphtalate-carbonate);
polycarbonate based on aliphatic dicarboxylic acids and mixtures thereof, PC+ABS, ASA (acrylonitrile-styrene-acrylester copolymer), AES (acrylonitrile-ethylene-propylene-diene-styrene copolymer), PMMA+PS, PET (polyethylene terephthalate), PPE+SB (polyphenyl ether+styrene-butadiene copolymer), PS-HI (polystyrene HI), PPE (polyphenyl ether), PP-cop (polypropylene copolymers), SMA (styrene-maleic anhydride copolymer), PTP, PBT (polybutyleneterephtalate), PTT (polytrimethylene terephthalate), PET+PBT, MSB, PSU (polysulfone);
thermoplastic polyester elastomers;
polyesters of aromatic diols and carboxylic acid, PAR (polyarylates), PBN (polybutylene naphtalate), PEN (polyethylene naphthalate);
polyarylsulfides and polyarylsulfones, PPS (polyphenylene sulfide), PASU, PSU (polysulfone), PES (polyethersulphone), PPSU (polyphenylenesulfone),
PSU+ABS;
polyarylketones and derivatives, PAEK (polyarylketone), PEK (polyetherketone), PEEK (polyether-etherketone), PEEEK (polyether-ether-ethereketone), PEKK (polyethereketoneketone), PEEKK (polyether-ether-ketoneketone), PEEKEK (polyether ether-ketonetherketone), PEKEEK (polyether-ketone-ether-etherketone), PAEK+PI (polyarylketone+polyimide);
thermoplastic polyimides, PAI (polyamidoimide), PEI (polyetherimide), PISO (polyimide-sulfone), PMI (polymethacrylimide), PMMI (polymethacryl-methylimide), PARI (polyarylimide), PESI (polyesterimide);
thermoplastic polyurethanes TPU;
resins based on unsaturated polyester UP;
epoxy resins EP;
natural polymers derived from cellulose and starch: CA (cellulose acetate), CTA (cellulose triacetate), CP (cellulose propionate), CAP (cellulose acetopropionate), CAB (cellulose acetate butyrate), NC (cellulose nitrate), EC (ethyl cellulose), MC (methylcellulose), CMC (carboxymethylcellulose), CH (hydrated cellulose), PSAC (polysaccharide starch); or mixtures thereof.

10. Thermoplastic material according to claim 1, comprising a plasticizer, preferably contained in a percentage by weight lower than 15% of the total weight of the material, more preferably between 2% and 12% by weight;
and/or additives selected from slipping agents, lubricants, stabilizers, antistatic agents, flame retardants, dyes, flexibilizers, fillers, reinforcing agents and foaming agents, preferably contained in a total percentage by weight lower than 15% of the total weight of the material, more preferably between 3% and 13% by weight.

11. Thermoplastic material according to claim 1, comprising an amount from 15% to 35% by weight of a thermoplastic polymer selected from a polyolefin, a styrene polymer or copolymer, a TPU or mixtures thereof, from 0% to 20% by weight of cross-linked waste polyurethane and from 30% to 60% by weight of natural and synthetic rubber mixture, wherein, preferably, the polyolefin is selected from polypropylene, polyethylene and HDPE; the styrene polymer or copolymer is selected from polystyrene and SBS; the natural or synthetic waste rubber is a ELT rubber powder and/or other articles.

12. Thermoplastic material according to claim 1, comprising an amount from 15% to 25% by weight of thermoplastic polyurethane (TPU) or SBS, from 10% to 20% by weight of cross-linked waste polyurethane in granules sized 1-5 mm, from 25% to 60% by weight of mixture of waste rubber powder with a grain size from 400 to 600 microns and EPDM, a plasticizer, preferably DIDP, in an amount of 8-10% by weight, dyes in an amount of 1-3% by weight, silica in an amount of 4-6% by weight, and a lubricant in an amount of 2-4% by weight.

13. Thermoplastic material according to claim 1, comprising an amount from 15% to 35% by weight of a polyolefin, preferably polypropylene, or of polystyrene, from 5% to 15% by weight of crosslinked waste polyurethane in granules sized 1-5 mm, from 25% to 60% by weight of a mixture of waste rubber powder with grain size from 400 microns to 3.5 mm and EPDM, a plasticizer, preferably dioctyl adipate, in an amount of 3-7% by weight, dyes in an amount of 1-3% by weight, silica in an amount of 4-6% by weight, and a lubricant in an amount of 2-4% by weight.

14. Thermoplastic material according to claim 1, comprising an amount from 20% to 35% by weight of a polyolefin, preferably HDPE, or of PVC (polyvinyl chloride), from 10% to 20% by weight of crosslinked waste polyurethane in granules sized 1-5 mm, from 25% to 60% by weight of a mixture of waste rubber powder with grain size from 400 to 600 microns and EPDM, a plasticizer, preferably dioctyl adipate, in an amount of 2-4% by weight, dyes in an amount of 1-3% by weight, silica in an amount of 4-6% by weight, and a lubricant in an amount of 2-4% by weight.

15. Sole for shoes made of a material according to claim 12.

16. Building material made of a material according to claim 13, wherein said building material is preferably a brick, an outdoor and indoor flooring, also raised, or an acoustic/thermal coating panel.

17. Process for making the thermoplastic material according to claim 1, comprising the following steps:
a) grinding the cross-linked polyurethane, when present;
b) grinding the natural or synthetic rubber to yield a powder;
c) intimately hot mixing the powder of step b) with EPDM to yield a homogeneous compound containing between 30% and 80% by weight of EPDM;
d) mixing the homogeneous compound of step c) and, when present, the ground cross-linked polyurethane with the thermoplastic polymer, up to the formation of a homogeneous mixture;
e) optionally, adding liquid components (e.g. plasticizers) to the mixture of step d) and further mixing in a turbo-mixer up to the absorption of the liquid;
f) extruding the mixture of step d) or e).

18. Thermoplastic material obtainable with the process of claim 17, having the following features:
i) for a compact material
specific weight of about 1 g/cc (determined by the ISO 2781: 2008 method),
volume loss due to abrasion (abrasion resistance determined by the UNI EN 12770: 2001 method) of between 100 and 150 mm 3 and
tear strength (determined by the ISO 20872 method) of between 15 and 20 N/mm, ii) for a foamed material
specific weight of about 0.60 g/cc (determined by the ISO 2781: 2008 method),
volume loss due to abrasion (abrasion resistance determined by the UNI EN 12770: 2001 method) of between 150 and 190 mm 3 and
tear strength (determined by the ISO 20872 method) of between 10 and 15 N/mm.

19. Thermoplastic material according to claim 7, wherein the ethylene-propylene-diene terpolymer (EPDM) consists of 45-75%, or about 70%, ethylene, 13-43%, or about 25%, propylene, and 2.5%-12%, or about 5%, diene, and wherein the diene is preferably ethylidene norbornene (ENB).
